(19) United States
(12) Patent Application Publication
(10) Pub. No.: US 2026/0268556 A1
(43) Pub. Date: Sep. 10, 2026

(54) SYSTEM

(71) Applicant: SOFTBANK GROUP CORP., Tokyo (JP)

(72) Inventor: Takahito KURUMIYA, Tokyo (JP)

(73) Assignee: SOFTBANK GROUP CORP., Tokyo (JP)

(21) Appl. No.: 19/555,985

(22) Filed: Mar. 4, 2026

Related U.S. Application Data
(60) Provisional application No. 63/767,145, filed on Mar. 5, 2025.

(51) Int. Cl. G06T 11/60; G06F 40/143

(52) U.S. Cl. CPC G06T 11/60; G06F 40/143; G06T 2200/24; G06T 2210/32

(57) ABSTRACT

A system for converting a website into a two-dimensional metaverse platform is disclosed. The system includes an acquisition unit, an analysis unit, a prompt generation unit, an image generation unit, a conversion unit, and a provision unit. The acquisition unit acquires HTML data of a website by issuing an HTTP request using a web crawler based on a URL input by a user. The analysis unit constructs a document object model (DOM) tree from the acquired HTML data and analyzes the DOM tree to identify the structural layout and content elements of the website, including text, images, links, and style information. Based on the analysis results, the prompt generation unit generates structured prompts suitable for input to an image generation artificial intelligence model. The image generation unit inputs the generated prompts into the image generation AI to generate image data that visually represents the respective website elements. The conversion unit arranges the generated image data within a two-dimensional virtual space and associates interactive operations with the arranged elements to form a 2D metaverse platform corresponding to the original website. The provision unit provides the generated metaverse platform to users via a terminal device and enables interactive operation within the virtual space. By automatically transforming website structure and content into a visually interactive two-dimensional metaverse space, the system enables efficient metaverse conversion of websites without requiring specialized technical knowledge, thereby providing new digital interaction experiences.

### CROSS-REFERENCE TO RELATED APPLICATION

This application claims priority under 35 U.S.C. § 119 to U.S. Provisional Patent Application No. 63/767,145, filed on Mar. 5, 2025, the entire contents of which are incorporated herein by reference.

### BACKGROUND

### Technical Field

The present disclosure relates to a system.

### Related Art

Japanese Patent Application Publication Laid-Open (JP-A) No. 2022-180282 discloses a persona chatbot control method performed by at least one processor, comprising: a step of receiving a user utterance; a step of adding to the user utterance a prompt containing a description of the chatbot's persona and related instructions; a step of encoding the prompt; and a step of inputting the encoded prompt into a language model to generate a chatbot utterance in response to the user utterance.

A system and method for significantly reducing the complexity and effort involved in converting a website into a metaverse, providing an efficient and automated process is provided. Conventionally, converting a website into a metaverse space required extensive specialized knowledge and skills, necessitating manual work by experts possessing design and programming expertise. This process was time-consuming and costly, posing a significant burden, particularly for small and medium-sized enterprises (SMEs) and individuals.

Furthermore, accurately reproducing website elements within the metaverse space was difficult, making it challenging to provide the interactive experience users expected. This invention solves these problems by automating a series of processes: automatically acquiring and analyzing the website's HTML information, visualizing it using image generation AI, and converting it into a 2D metaverse platform.

This enables users to easily metaverse-ify their websites and provide interactive experiences without requiring specialized knowledge. Furthermore, as it is provided via a SaaS model, users can minimize initial investment while receiving continuous updates and support. The goal is to make website metaverse-ification more accessible and convenient, thereby widely popularizing new digital experiences.

As a means to solve the problem, a system for realizing the metaverse conversion of websites is provided. This system comprises: an acquisition unit that acquires the HTML information of a website; an analysis unit that analyzes the acquired HTML information to identify the site's structure and content, a prompt generation unit that generates prompts suitable for image generation AI based on the analysis results, an image generation unit that visualizes site elements using the generated prompts, a conversion unit that converts the visualized site elements into a 2D metaverse platform, and a provision unit that provides the converted 2D metaverse to users.

First, the acquisition unit extracts HTML data from the specified website using web crawler functionality based on the URL input by the user. Next, the analysis unit analyzes the extracted HTML data to determine the site's layout, text, images, links, and style information. It further evaluates the site's interactivity by considering dynamic elements implemented via JavaScript. This enables detailed identification of the site's structure and content.

The prompt generation unit generates prompts for each element of the site identified by the analysis unit. These prompts contain specific instructions enabling the image generation AI to accurately reproduce the elements. These prompts serve as guidelines for precisely recreating the site's visual components. The image generation unit then generates images visually representing each element of the site based on the generated prompts.

The conversion unit places the generated images within a 2D space, enabling users to interact with them. This allows website elements to be reproduced within a 2D metaverse space, providing users with a new experience.

The provision unit delivers the converted 2D metaverse to the user, enabling rapid and efficient metaverse conversion of the website. In this way, the entire process for converting a website into a metaverse is automated without requiring specialized knowledge, enabling the delivery of new digital experiences to users.

### BRIEF DESCRIPTION OF THE DRAWING

FIG. 1 is a conceptual diagram showing an example configuration of the data processing system according to the first embodiment.

FIG. 2 is a conceptual diagram showing an example of key functional components of the data processing device and smart device according to the first embodiment.

FIG. 3 is a conceptual diagram showing an example configuration of the data processing system according to the second embodiment.

FIG. 4 is a conceptual diagram showing an example of the main functions of the data processing device and smart glasses according to the second embodiment.

FIG. 5 is a conceptual diagram showing an example configuration of a data processing system according to a third embodiment.

FIG. 6 is a conceptual diagram showing an example of the main functions of the data processing device and headset-type terminal according to the third embodiment.

FIG. 7 is a conceptual diagram showing an example configuration of a data processing system according to the fourth embodiment.

FIG. 8 is a conceptual diagram showing an example of the main functions of the data processing device and robot according to the fourth embodiment.

FIG. 9 shows an emotion map onto which multiple emotions are mapped.

FIG. 10 shows an emotion map onto which multiple emotions are mapped.

### DETAILED DESCRIPTION

The following describes an example embodiment of a system according to the present disclosure with reference to the accompanying drawings.

First, the terminology used in the following description is explained.

In the following embodiments, the signed processor (hereinafter referred to simply as the “processor”) may be a single arithmetic unit or a combination of multiple arithmetic units. Furthermore, the processor may be a single type of arithmetic unit or a combination of multiple types of arithmetic units. Examples of processing units include a CPU (Central Processing Unit), a GPU (Graphics Processing Unit), a GPGPU (General-Purpose Computing on Graphics Processing Units), an APU (Accelerated Processing Unit), and the like.

In the following embodiments, signed RAM (Random Access Memory) is a memory where information is temporarily stored and is used as working memory by the processor.

In the following embodiments, the signed storage is one or more non-volatile storage devices that store various programs and various parameters, etc. Examples of non-volatile storage devices include flash memory (SSD (Solid State Drive)), magnetic disks (e.g., hard disk), or magnetic tape.

In the following embodiment, the coded communication interface is an interface including a communication processor and an antenna, etc. The communication interface governs communication between multiple computers. Examples of communication standards applicable to the communication interface include wireless communication standards such as 5G (5th Generation Mobile Communication System), Wi-Fi (registered trademark), or Bluetooth (registered trademark).

In the following embodiments, “A and/or B” is synonymous with “at least one of A and B.” That is, “A and/or B” may mean A alone, B alone, or a combination of A and B. Furthermore, in this specification, when three or more items are connected using “and/or,” the same concept applies as for “A and/or B”.

### First Embodiment

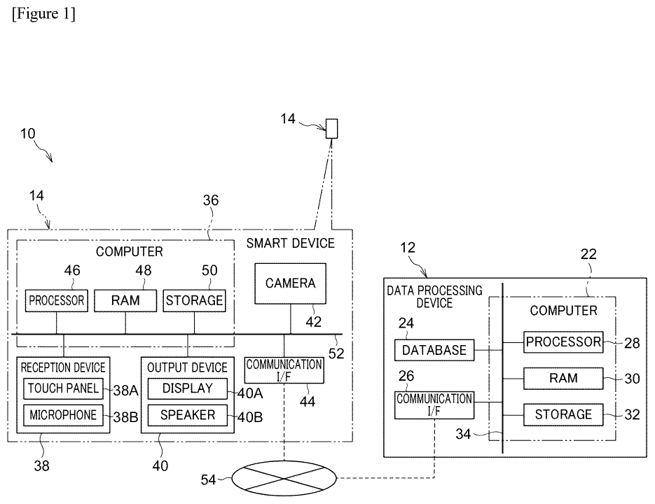

FIG. 1 shows an example configuration of the data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 is an example of a “computer” according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is WAN (Wide Area Network) and/or LAN (Local Area Network) are examples.

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52. The reception device 38, output device 40, and camera 42 are also connected to the bus 52.

The reception device 38 includes a touch panel 38A and a microphone 38B, among other components, and receives user input. The touch panel 38A receives user input via contact with an indicator (e.g., a pen or finger) by detecting such contact. The microphone 38B receives voice-based user input by detecting the user's voice. The control unit 46A transmits data indicating user input received via the touch panel 38A and microphone 38B to the data processing unit 12. The data processing device 12 acquires the data indicating the user input via the specific processing unit 290.

The output device 40 includes a display 40A and a speaker 40B, among others. It presents data to the user 20 by outputting it in a form perceptible to the user 20 (e.g., voice and/or text). The display 40A displays visual information such as text and images according to instructions from the processor 46. The speaker 40B outputs voice according to instructions from the processor 46. The camera 42 is a compact digital camera equipped with an optical system, including a lens, aperture, and shutter, and an imaging element, such as a CMOS (Complementary Metal-Oxide-Semiconductor) image sensor or a CCD (Charge Coupled Device) image sensor.

The communication interface 44 is connected to the network 54. The communication interfaces 44 and 26 manage the exchange of various information between processor 46 and processor 28 via network 54.

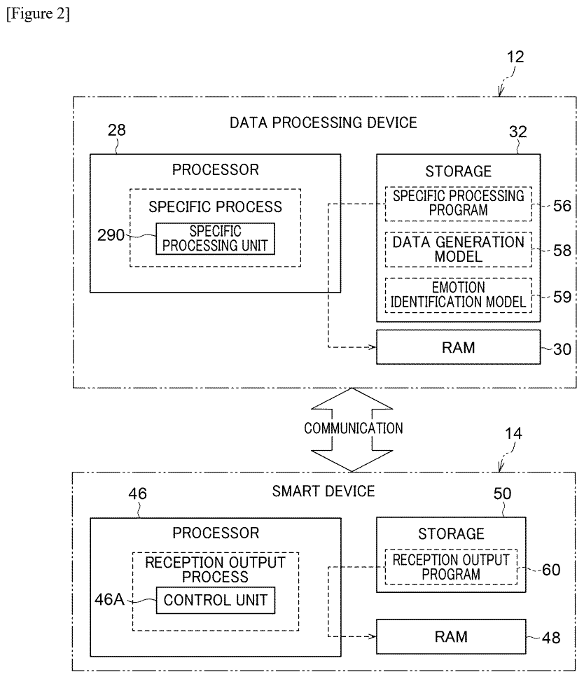

FIG. 2 shows an example of the main functions of the data processing device 12 and the smart device 14.

As shown in FIG. 2, specific processing is performed by processor 28 in data processing device 12. Specific processing program 56 is stored in storage 32. Specific processing program 56 is an example of a “program” related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

The smart device 14 performs reception output processing via the processor 46. The reception output program 60 is stored in the storage 50. The reception output program 60 is used in conjunction with the specific processing program 56 by the data processing system 10. The processor 46 reads the reception output program 60 from the storage 50 and executes the read reception output program 60 on the RAM 48. The specific processing is performed by the processor 46 operating as a control unit 46A according to the specific processing program 60 executed on the RAM 48. Note that the smart device 14 may also have data generation models and emotion identification models similar to the data generation model 58 and emotion identification model 59, and may perform processing similar to that of the specific processing unit 290 using these models. The reception output processing is realized by the processor 46 operating as the control unit 46A according to the reception output program 60 executed on the RAM 48.

Other devices besides the data processing device 12 may also have the data generation model 58. For example, a server device (e.g., a generation server) may have the data generation model 58. In this case, the data processing device 12 communicates with the server device having the data generation model 58 to obtain processing results (such as prediction results) obtained using the data generation model 58. Furthermore, the data processing device 12 may itself be a server device, or it may be a terminal device owned by a user (e.g., a mobile phone, robot, home appliance, etc.) owned by a user. Next, an example of processing by the data processing system 10 according to the first embodiment is described.

### EXAMPLE 1

The flow of specific processing in Example 1 is described below. The components of the system described below are implemented by the data processing device 12 and the smart device 14. The data processing device 12 is referred to as the “server,” and the smart device 14 is referred to as the “terminal.”

### Embodiments for Implementing the Present Invention

The present invention will now be described in more detail with reference to an embodiment for implementing the invention, specifically describing the details of realizing a system using a server and a terminal.

The entire system efficiently achieves website metaverse conversion by dividing functions between the server and the user's terminal. The server handles primary processing such as data acquisition, analysis, prompt generation, image generation, and conversion, while the terminal provides the user interface and handles interaction.

First, the acquisition component on the server side is described. The acquisition component receives a URL input by the user from the terminal and uses web crawler functionality to acquire the HTML data of the specified website on the server. During this process, the acquisition component issues an HTTP request and downloads the HTML document from the server. For example, entering a news site URL retrieves the HTML data for that site's homepage. This process checks the robots. txt file to determine if crawling is permitted. Additionally, to handle dynamically generated content, executing JavaScript to render the complete page is also considered.

Next, the parsing unit is described. The parsing unit analyzes the retrieved HTML data on the server to gain a detailed understanding of the site's structure. Specifically, it constructs a DOM tree, parses each node, and extracts the site's layout, text, images, links, and style information. For example, it parses ‘<div>’ tags to identify content sections and extracts image URLs from ‘<img>’ tags. It also parses CSS files to obtain style information for each element. Furthermore, it considers dynamically generated elements via JavaScript and parses event listeners to identify user interaction patterns.

The prompt generation unit generates prompts on the server for each element of the site identified by the parsing unit. These prompts contain specific instructions for the image generation AI to accurately reproduce the site. The prompts include detailed instructions such as color, font, layout, and placement. For example, the header section might include instructions like “Display the title in white text on a blue background,” while the main content might include instructions like “Arrange images and text in a three-column grid layout.” This prompt is structured in JSON format and passed to the image generation AI.

The image generation unit uses the generated prompt to create images on the server that visually represent the site elements. The image generation AI reproduces each element with high precision based on the prompt. For example, each section of the site (header, main content, sidebar, footer) is generated as a separate image. This visually recreates the site's layout and design. The generated images are saved in formats such as SVG or PNG and for use in subsequent processes.

The conversion unit converts the generated images into a 2D metaverse platform on the server. This conversion places the images within a 2D space, enabling users to interact with them. Specifically, the images are arranged in a tiled pattern, with interactions defined for each tile. For example, interactions such as clicking to navigate to a link, zooming in on an image, or highlighting text become possible. This allows website elements to be reproduced within the 2D metaverse space, enabling the provision of new experiences to users.

On the terminal side, a provisioning unit is implemented. The provisioning unit provides the 2D metaverse sent from the server to the user, enabling interactive operation. The terminal enables operations within the metaverse space through a web browser or dedicated application, allowing users to intuitively enjoy the experience. For example, users can navigate the metaverse space or select specific elements using the terminal's touchscreen. Furthermore, the terminal transmits user operations to the server in real time and immediately reflects the processing results on the server side, achieving a smooth user experience.

In this way, the collaboration between the server and the terminal efficiently enables the metaverse transformation of websites, providing users with new digital experiences. This embodiment automates the entire process for metaverse transformation of websites without requiring specialized knowledge, thereby delivering new value to users.

### System Configuration

The system according to this embodiment comprises an acquisition unit, an analysis unit, a prompt generation unit, an image generation unit, a conversion unit, and a provision unit. The acquisition unit uses a web crawler function to acquire the HTML data of the specified website on the server based on the URL input by the user from the terminal. Specifically, the acquisition unit issues an HTTP request and downloads the HTML document from the server. At this time, it checks the robots.txt file to determine if crawling is permitted. For example, entering the URL of a news site or blog site allows the HTML information for that site to be automatically acquired. Furthermore, to handle dynamically generated content, executing JavaScript to render the complete page is also considered. Additionally, the acquisition unit can crawl multiple pages to collect information for the entire site, thereby enabling an understanding of the site's overall structure.

The Parsing Department analyzes the acquired HTML data on the server to gain a detailed understanding of the site's structure. Specifically, it constructs a DOM tree, parses each node, and extracts the site's layout, text, images, links, and style information. For example, it parses ‘<div>’ tags to identify content sections and extracts image URLs from ‘<img>’ tags. It also parses CSS files to obtain style information for each element. Furthermore, it considers dynamic elements created by JavaScript, parsing event listeners to identify patterns of user interaction. The Parsing Unit can also analyze the link structure within a page to identify navigation paths within the site. This enables understanding how users move through the site.

The prompt generation unit generates prompts on the server for each element of the site identified by the analysis unit. These prompts contain specific instructions for the image generation AI to accurately reproduce the elements, prompt includes detailed instructions such as color, font, layout, and placement. For example, instructions might include “Display the title in white text on a blue background” for the header section, “Arrange images and text in a three-column grid layout” for the main content, and “Place links in small white text on a black background” for the footer. This prompt is structured in JSON format and passed to the image generation AI. The prompt generation section can also include instructions to maintain visual consistency by considering the site's theme and brand colors.

The image generation component uses the generated prompt to create images visually representing the site elements on the server. The image generation AI reproduces each element with high precision based on the prompt. For example, each section of the site (header, main content, sidebar, footer) is generated as a separate image. This visually recreates the site's layout and design. The generated images are saved in formats such as SVG or PNG for use in subsequent processes. The image generation unit can also adjust the resolution and file format of the generated images and perform processing to achieve optimal display.

The conversion unit converts the generated images into a 2D metaverse platform on the server. This conversion places the images within a 2D space, enabling users to interact with them. Specifically, the images are arranged in a tiled pattern, with interactions defined for each tile. For example, interactions like clicking to navigate to a link, zooming in on an image, or highlighting text become possible. The conversion unit updates the display in real time based on user operations, providing a smooth user experience.

The provision unit provides the 2D metaverse sent from the server to the user, enabling interactive operation. The terminal enables operation within the metaverse space via a web browser or dedicated application, allowing users to intuitively enjoy the experience. For example, users can navigate the metaverse space or select specific elements using the terminal's touchscreen. Furthermore, the terminal transmits user operations to the server in real time and immediately reflects the processing results on the server side, thereby achieving a smooth user experience. The provision unit can also collect and analyze user operation logs to understand user behavior patterns and utilize this information for service improvement.

In this way, the collaboration between the server and the terminal enables the efficient metaverse transformation of websites, providing users with new digital experiences. This embodiment automates the entire process for metaverse transformation of websites without requiring specialized knowledge, thereby delivering new value to users.

### Implementation Steps

### Step 1: Acquisition of HTML Information

Based on the URL input by the user from the terminal, the acquisition unit uses web crawler functionality to retrieve the HTML data of the specified website on the server. This process involves issuing an HTTP request and downloading the HTML document from the server. It checks the robots. txt file to determine if crawling is permitted. For example, entering a URL for a news site or blog site allows the HTML information for that site to be automatically retrieved. To handle dynamically generated content, executing JavaScript to render the complete page is also considered. Furthermore, the retrieval component can crawl multiple pages to gather information about the entire site, enabling it to grasp the site's overall structure.

### Step 2: HTML Data Analysis

The parsing unit analyzes the retrieved HTML data on the server to gain a detailed understanding of the site's structure. Specifically, it constructs a DOM tree, parses each node, and extracts the site's layout, text, images, links, and style information. For example, it parses ‘<div>’ tags to identify content sections and extracts image URLs from ‘<img>’ tags. Additionally, it parses CSS files to obtain style information for each element. Furthermore, it considers dynamic elements driven by JavaScript, parsing event listeners to identify and identify user interaction patterns. The parsing unit can also analyze the link structure within a page to identify navigation paths within the site. This enables understanding how users move through the site.

### Step 3: Prompt Generation

For each site element identified by the analysis unit, the prompt generation unit creates prompts on the server containing specific instructions for the image generation AI to accurately reproduce. These prompts include detailed instructions such as color, font, layout, and placement. For example, for the header section: “Display the title in white text on a blue background”; for the main content: “Arrange images and text in a three-column grid layout,” with instructions like “Place links in small white text on a black background” for the footer. This prompt is structured in JSON format and passed to the image generation AI. The prompt generation component can also include instructions to maintain visual consistency, considering the site's theme and brand colors.

### Step 4: Image Generation

Using the generated prompt, the image generation component creates images on the server that visually represent the site elements. The image generation AI reproduces each element with high precision based on the prompt. For example, each section of the site (header, main content, sidebar, footer) is generated as a separate image. This visually recreates the site's layout and design. The generated images are saved in formats such as SVG or PNG for use in subsequent processes. The image generation unit can also adjust the resolution and file format of the generated images and perform processing to achieve optimal display.

### Step 5: Conversion to 2D Metaverse

The conversion unit converts the generated images into a 2D metaverse platform on the server. This conversion places the images within a 2D space, enabling users to interact with them. Specifically, the images are arranged in a tiled pattern, with interactions defined for each tile. For example, interactions like clicking to navigate to a link, zooming in on an image, or highlighting text become possible. The conversion unit updates the display in real time based on user actions, providing a smooth user experience.

### Step 6: Provision to User

The provision unit delivers the 2D metaverse sent from the server to the user, enabling interactive operation. The terminal enables operation within the metaverse space via a web browser or dedicated application, allowing users to intuitively enjoy the experience. For example, users can navigate the metaverse space or select specific elements using the terminal's touchscreen. Furthermore, the terminal sends user operations to the server in real time and immediately reflects the server-side processing results, achieving a smooth user experience. The provision unit can also collect and analyze user operation logs to understand user behavior patterns and utilize this information for service improvement.

### Specific Use Cases

For example, consider an educational institution considering transforming its website into a metaverse. This institution provides online information to students and faculty, with its website containing content such as lecture schedules, event calendars, faculty profiles, and campus tours. By transforming this website into a metaverse, the goal is to provide a more interactive and immersive experience, thereby enhancing student engagement.

First, the institution's administrator inputs the website URL into the system. The acquisition unit uses a web crawler to retrieve HTML data based on this URL. During this process, it checks the robots.txt file to determine if crawling is permitted. The acquired HTML data is parsed by the parsing unit, extracting the site's structure, text, images, links, and style information. For example, the lecture information section is identified as a text block enclosed by ‘<div>’ tags, while the event calendar is parsed as data structured in a table format.

Based on the parsing results, the prompt generation unit generates prompts suitable for the image generation AI. These prompts contain specific instructions for visually reproducing each element of the site. For example, instructions for the lecture information section might include “Display lecture names and times in black text on a white background,” while instructions for the event calendar might include “Arrange dates and event names in a grid layout.” A specific example of such a prompt could be: “Display the educational institution's name in white text on a blue background in the header section. Arrange lecture information, the event calendar, and faculty introductions in a three-column layout for the main content.”

Using the generated prompts, the image generation unit creates images that visually represent the site elements. This visually recreates the lecture information and event calendar, enabling users to intuitively grasp the information. The generated images are saved in SVG or PNG format and converted by the conversion unit into the 2D metaverse platform. This conversion places the images within the 2D space, allowing users to interact with them.

The provision unit provides the converted 2D metaverse to users, enabling students and faculty to interact within the metaverse space via web browsers or dedicated applications. For example, students can navigate campus tours using touchscreens or click on lecture information to view details. Furthermore, user interactions are transmitted to the server in real time, with server-side processing results reflected instantly, ensuring a smooth user experience.

In this way, educational institution websites become more attractive and interactive platforms through metaverse conversion, enabling them to provide new digital experiences for students and faculty.

### Application Example 1

The flow of specific processing in Application Example 1 is described below. The components of the system described below are implemented by the data processing device 12 and the smart device 14. The data processing device 12 is referred to as the “server,” and the smart device 14 is referred to as the “terminal.”

### Implementation Examples for the Present Invention

The present invention is a system for realizing the metaverse transformation of a virtual store, comprising an acquisition unit, an analysis unit, a prompt generation unit, an image generation unit, a conversion unit, and a provision unit.

First, the acquisition unit acquires HTML data using a web crawler based on the URL of the virtual store's website or online catalog input by the user. The crawler issues HTTP requests to download HTML documents from specified URLs. During this process, it checks the robots.txt file to determine if crawling is permitted. For example, by entering the URL of a fashion brand's online store, it can automatically retrieve HTML information for the site's homepage and product detail pages. The acquisition unit also considers executing JavaScript to render complete pages, enabling it to handle dynamically generated content. Furthermore, the acquisition unit can crawl multiple pages to collect information across the entire site, thereby providing an overview of the site.

Next, the parsing unit analyzes the retrieved HTML data to extract product categories, detailed information, images, and pricing information. The parsing unit constructs a DOM tree, parses each node, and extracts the site's layout, text, images, links, and style information. For example, it parses ‘<div>’ tags to identify product sections and extracts product image URLs from ‘<img>’ tags. It also parses CSS files to obtain style information for each element. Furthermore, it considers dynamic elements via JavaScript, parsing event listeners to identify user interaction patterns. The parsing unit can also analyze the link structure within a page to identify navigation paths within the site. This enables understanding how users move within the site.

The prompt generation unit generates prompts for each site element identified by the analysis unit. These prompts contain specific instructions for the image generation AI to accurately reproduce the elements. The prompts include detailed instructions such as product placement, color, size, and price display. For example, instructions might specify placing a red dress centrally on the main display with its price prominently displayed below, or arranging accessories on the left shelf with small price tags beneath each item. This prompt is structured in JSON format and passed to the image generation AI. The prompt generation unit can also include instructions to maintain visual consistency, considering the product theme and brand colors.

The image generation unit uses the generated prompt to create an image visually representing the site elements. The image generation AI accurately reproduces the product placement and design based on the prompt. For example, the product display is visually represented and laid out to make it easy for users to select items. The generated image is saved in formats like SVG or PNG for use in subsequent processes. The image generation unit can also adjust the resolution and file format of the generated image and perform processing to achieve optimal display.

The conversion unit converts the generated images into a 2D metaverse platform. This conversion places the images within a 2D space, enabling users to interact with them. Specifically, images are arranged in a tiled pattern, with interactions defined for each tile. For example, when a user clicks a product image, interactions such as displaying detailed information in a pop-up or navigating to the purchase page become possible. The conversion unit updates the display in real time based on user operations, providing a smooth user experience.

The provision unit provides users with a metaverse-enabled virtual store, allowing them to select products and view detailed information. The terminal enables operations within the metaverse space via a web browser or dedicated application, allowing users to intuitively enjoy the experience. For example, users can navigate the metaverse space or select specific elements using the terminal's touchscreen. Furthermore, the terminal transmits user operations to the server in real time and immediately reflects the processing results on the server side, thereby achieving a smooth user experience. The provision unit can also collect and analyze user operation logs to understand user behavior patterns and utilize this information for service improvement.

In this way, the collaboration between the server and the terminal efficiently enables the metaverse transformation of virtual stores, providing users with new digital experiences. This embodiment automates the entire process for metaverse transformation of virtual stores without requiring specialized knowledge, thereby delivering new value to users.

### System Configuration

The system according to this embodiment comprises an acquisition unit, an analysis unit, a prompt generation unit, an image generation unit, a conversion unit, and a provision unit. The acquisition unit acquires HTML data using a web crawler based on the URL of the virtual store's website or online catalog input by the user. The acquisition unit issues HTTP requests to download HTML documents from the specified URLs. It checks the robots. txt file to determine if crawling is permitted. For example, inputting the URL of a fashion brand's online store allows automatic acquisition of HTML information for the site's top page and product detail pages. The acquisition unit also considers executing JavaScript to render complete pages, enabling handling of dynamically generated content. Furthermore, the acquisition unit can crawl multiple pages to collect information across the entire site, thereby grasping the site's overall structure.

The parsing unit analyzes the retrieved HTML data to extract product categories, detailed information, images, and pricing data. It constructs a DOM tree, parses each node, and extracts the site's layout, text, images, links, and style information. For example, it parses ‘<div>’ tags to identify product sections and extracts product image URLs from ‘<img>’ tags. It also parses CSS files to obtain style information for each element. Furthermore, it considers dynamically generated elements via JavaScript, parsing event listeners to identify user interaction patterns. The parsing unit can also analyze the link structure within a page to identify navigation paths within the site. This enables understanding how users move through the site.

The prompt generation unit creates prompts for each element identified by the analysis unit on the site, containing specific instructions for the image generation AI to accurately reproduce. These prompts include detailed instructions such as product placement, color, size, and price display. For example, instructions might include placing a red dress centrally on the main display with its price prominently displayed below, arranging accessories on the left shelf, and attaching small price tags beneath each item. These prompts are structured in JSON format and passed to the image generation AI. The prompt generation unit can also include instructions to maintain visual consistency, considering the product theme and brand colors.

The image generation unit uses the generated prompt to create an image visually representing the site elements. The image generation AI accurately reproduces the product placement and design based on the prompt. For example, the product display is visually represented and laid out to make it easy for users to select items. The generated image is saved in formats like SVG or PNG for use in subsequent processes. The image generation unit can also adjust the resolution and file format of the generated image and perform processing to achieve optimal display.

The conversion unit converts the generated images into a 2D metaverse platform. This conversion places the images within a 2D space, enabling users to interact with them. Specifically, images are arranged in a tiled pattern, with interactions defined for each tile. For example, when a user clicks a product image, interactions such as displaying detailed information in a pop-up or navigating to the purchase page become possible. The conversion unit updates the display in real time based on user operations, providing a smooth user experience.

The Provision Unit provides users with a metaverse-enabled virtual store where they can select products and view detailed information. The terminal enables operations within the metaverse space via a web browser or dedicated application, allowing users to intuitively enjoy the experience. For example, users can navigate the metaverse space or select specific elements using the terminal's touchscreen. Furthermore, the terminal transmits user operations to the server in real time and immediately reflects the processing results on the server side, achieving a smooth user experience. The provision unit can also collect and analyze user operation logs to understand user behavior patterns and utilize this information for service improvement.

In this way, the collaboration between the server and the terminal efficiently enables the metaverse transformation of virtual stores, providing users with new digital experiences. This embodiment automates the entire process for metaverse transformation of virtual stores without requiring specialized knowledge, thereby delivering new value to users.

### Implementation Steps

### Step 1: Acquisition of HTML Data

When a user inputs the URL of a virtual store's website or online catalog, the acquisition unit uses a web crawler to obtain the HTML data. The acquisition unit issues an HTTP request and downloads the HTML document from the specified URL. At this time, it checks the robots.txt file to determine if crawling is permitted. For example, entering the URL of a fashion brand's online store allows automatic retrieval of HTML information for the site's top page and product detail pages. To handle dynamically generated content, the acquisition unit may also execute JavaScript to render complete pages. Furthermore, the acquisition unit can crawl multiple pages to collect information across the entire site, enabling a comprehensive understanding of the site's structure.

### Step 2: HTML Data Analysis

The parsing unit analyzes the retrieved HTML data to extract product categories, detailed information, images, and pricing data. The parsing unit constructs a DOM tree, analyzes each node, and extracts the site's layout, text, images, links, and style information. For example, it parses ‘<div>’ tags to identify product sections and extracts product image URLs from ‘<img>’ tags. It also parses CSS files to obtain style information for each element. Furthermore, it considers dynamic elements via JavaScript, parsing event listeners to identify user interaction patterns. The parsing unit can also analyze the link structure within a page to identify navigation paths within the site. This enables understanding how users move within the site.

### Step 3: Prompt Generation

For each site element identified by the analysis unit, the prompt generation unit creates prompts containing specific instructions for the image generation AI to accurately reproduce. These prompts include detailed instructions such as product placement, color, size, and price display. For example, instructions might specify placing a red dress centrally on the main display with its price prominently displayed below, or arranging accessories on the left shelf with small price tags beneath each item. This prompt is structured in JSON format and passed to the image generation AI. The prompt generation unit can also include instructions to maintain visual consistency, considering the product theme and brand colors.

### Step 4: Image Generation

Using the generated prompt, the image generation unit creates an image visually representing the site elements. The image generation AI accurately reproduces the product placement and design based on the prompt. For example, the product display is visually represented and laid out to make it easy for users to select items. The generated images are saved in formats like SVG or PNG for use in subsequent processes. The image generation unit can also adjust the resolution and file format of the generated images and perform processing to achieve optimal display.

### Step 5: Conversion to 2D Metaverse

The conversion unit converts the generated images into a 2D metaverse platform. This conversion places the images within a 2D space, enabling users to interact with them. Specifically, images are arranged in a tiled pattern, with interactions defined for each tile. For example, when a user clicks a product image, interactions such as displaying detailed information in a pop-up or navigating to the purchase page become possible. The conversion unit updates the display in real time based on user actions, providing a smooth user experience.

### 6: Providing to the User

The Provision Department provides users with a metaverse-enabled virtual store where they can select products and view detailed information. Terminals enable operation within the metaverse space via web browsers or dedicated applications, allowing users to intuitively enjoy the experience. For example, users can navigate the metaverse space or select specific elements using the terminal's touchscreen. Furthermore, the terminal transmits user operations to the server in real time and immediately reflects the processing results on the server side, achieving a smooth user experience. The provider can also collect and analyze user operation logs to understand user behavior patterns and utilize this information for service improvement.

### Specific Use Cases

For example, consider a furniture retailer considering transforming its online store into a metaverse. This retailer aims to provide users with a more interactive and immersive shopping experience. The online store features furniture categorized into sections like living rooms, bedrooms, and dining rooms, each containing detailed product information, images, prices, and inventory status.

First, the retailer inputs the online store's URL into the system. The acquisition unit uses a web crawler to retrieve HTML data based on this URL. The acquired data includes category pages, product detail pages, promotion pages, and more. The acquisition unit fully renders content dynamically generated by executing JavaScript to collect all necessary information.

Next, the analysis unit parses the retrieved HTML data to extract product categories, detailed information, images, and pricing data. For example, it identifies information for sofas and tables in the living room category and extracts product image URLs from ‘<img>’ tags. It also parses CSS files to obtain style information for each product. The analysis unit analyzes the link structure within the page to understand how users navigate the site.

Based on the analysis results, the prompt generation unit generates prompts suitable for image generation AI. These prompts include instructions regarding product placement, color, size, price display, etc. Examples of specific prompts include: “Place a blue sofa centrally as the main display in the living room, with the price displayed large below it,” or “Arrange chairs on the left shelf in the dining room, with small price tags beneath each product.” These prompts serve as guidelines for accurately reproducing the product visuals.

Using the generated prompts, the image generation unit creates the product visuals. The image generation AI accurately reproduces the product placement and design based on the prompts. For example, the living room display is visually represented with a layout that makes it easy for users to select products. The generated images are saved in SVG or PNG format for use in subsequent processes.

The conversion unit converts the generated images into a 2D metaverse platform. This conversion places the products within a 2D space, enabling users to interact with them. Specifically, product images are arranged in a tiled pattern, with interactions defined for each tile. For example, clicking a product image might trigger interactions such as displaying detailed information in a pop-up or redirecting the user to a purchase page.

The provision unit provides users with a metaverse-enabled virtual store where they can select products and view detailed information. Users can navigate the virtual store using touchscreens or VR devices via a web browser or dedicated application. For example, users can walk around a virtual showroom, pick up items of interest to examine details, and make purchases. Furthermore, user operations are transmitted to the server in real time, and the results of server-side processing are immediately reflected, enabling a smooth user experience.

In this way, furniture retailers can leverage metaverse technology to provide a more attractive and interactive platform, offering users a new digital shopping experience.

The specific processing unit 290 transmits the results of the specific processing to the smart device 14. On the smart device 14, the control unit 46A instructs the output device 40 to output the results of the specific processing. The microphone 38B acquires audio indicating user input regarding the results of the specific processing. The control unit 46A transmits the audio data indicating the user input acquired by the microphone 38B to the data processing unit 12. At the data processing unit 12, the specific processing unit 290 acquires the audio data.

Data Generation Model 58 is a so-called generative AI (Artificial Intelligence). An example of a data generation model 58 is ChatGPT (registered trademark) (Internet search <URL:https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart device 14.

### Second Embodiment

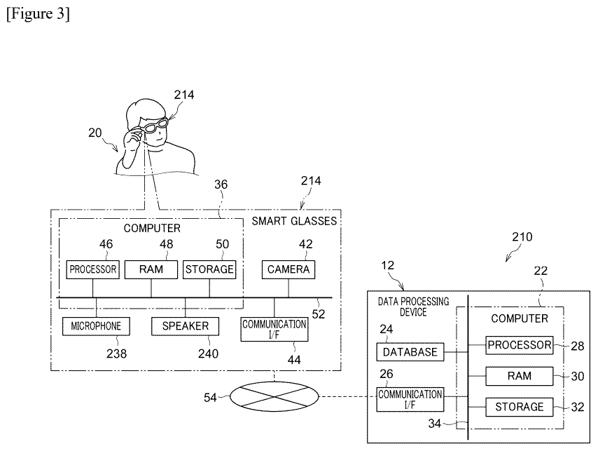

FIG. 3 shows an example configuration of the data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 is an example of a “computer” according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is WAN (Wide Area Network) and/or LAN (Local Area Network) are examples.

Smart glasses 214 are equipped with a computer 36, a microphone 238, a speaker 240, a camera 42, and a communication I/F 44. The computer 36 includes a processor 46, RAM 48, and storage 50. Processor 46, RAM 48, and storage 50 are connected to bus 52. Microphone 238, speaker 240, and camera 42 are also connected to bus 52.

Microphone 238 receives voice input from user 20 to accept instructions and the like. Microphone 238 captures the voice input from user 20, converts the captured voice into audio data, and outputs it to processor 46. Speaker 240 outputs audio according to instructions from processor 46.

Camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

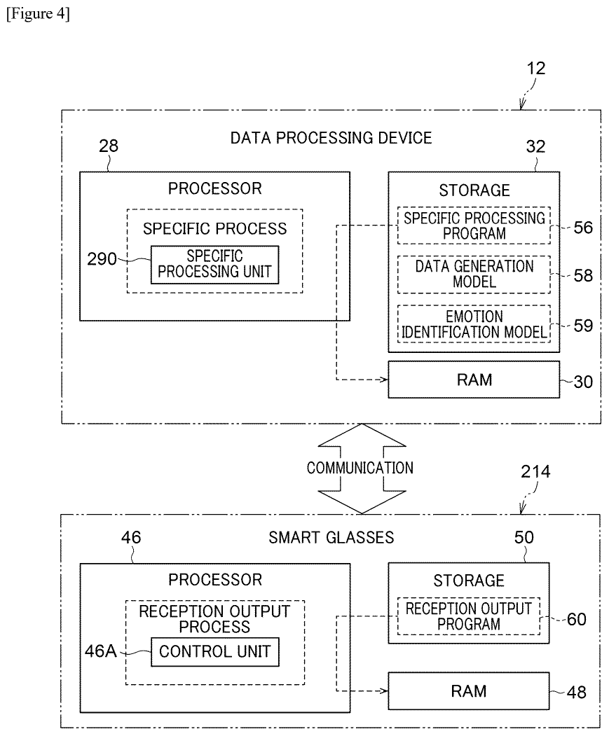

FIG. 4 shows an example of key functions of the data processing device 12 and the smart glasses 214. As shown in FIG. 4, specific processing is performed by the processor 28 in the data processing device 12. The specific processing program 56 is stored in the storage 32.

The specific processing program 56 is an example of a “program” related to the technology of this disclosure. Processor 28 reads the specific processing program 56 from storage 32 and executes the read specific processing program 56 on RAM 30. The specific processing is realized by processor 28 operating as specific processing unit 290 according to the specific processing program 56 executed on RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

In the smart glasses 214, the processor 46 performs the reception output processing. The reception output program 60 is stored in the storage 50. The processor 46 reads the reception output program 60 from the storage 50 and executes the read reception output program 60 on the RAM 48. The reception output processing is realized by the processor 46 operating as the control unit 46A according to the reception output program 60 executed on the RAM 48. Note that the smart glasses 214 may also have a data generation model 58 and an emotion identification model 59, and can perform processing similar to that of the identification processing unit 290 using these models.

Next, the identification processing performed by the identification processing unit 290 of the data processing device 12 is described. The components of the system described below are implemented by the data processing device 12 and the smart glasses 214. In the following description, the data processing device 12 is referred to as the “server,” and the smart glasses 214 are referred to as the “terminal.”

### EXAMPLE 1

The flow of the specific processing is the same as that described in Example 1 of the first embodiment, so the explanation is omitted.

### Application Example 1

The flow of the specific processing in Example 1 described in the first embodiment is the same, so the explanation is omitted.

The specific processing unit 290 transmits the result of the specific processing to the smart glasses 214. In the smart glasses 214, the control unit 46A causes the speaker 240 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is a so-called generative AI (Artificial Intelligence). An example of a data generation model 58 is ChatGPT (registered trademark) (Internet search <URL:https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, multimodal generation AI, etc. Here, inference refers to, for example, analysis, classification, prediction, and/or summarization. The specific processing unit 290 performs the specific processing described above while using the data generation model 58. The data generation model 58 may be a model fine-tuned to output inference results from prompts that do not contain instructions. In this case, the specific processing unit 290 performs the specific processing described above while using the data generation model 58. Data generation model 58 may be a fine-tuned model capable of outputting inference results from prompts that do not contain instructions. In this case, data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned parts is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart glasses 214.

### Third Embodiment

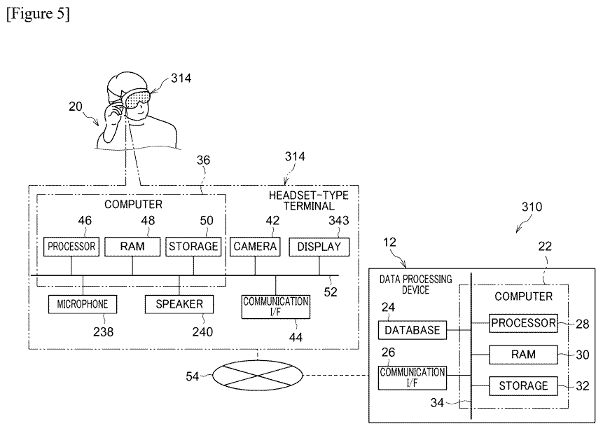

FIG. 5 shows an example configuration of the data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 is an example of a “computer” according to the technology of the present disclosure. The computer 22 includes a processor 28, RAM 30, and storage 32. The processor 28, RAM 30, and storage 32 are connected to bus 34. The database 24 and communication I/F 26 are also connected to bus 34. The communication I/F 26 is connected to network 54. Examples of network 54 include a WAN (Wide Area Network) and/or a LAN (Local Area Network).

The headset-type terminal 314 includes a computer 36, a microphone 238, a speaker 240, a camera 42, a communication I/F 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

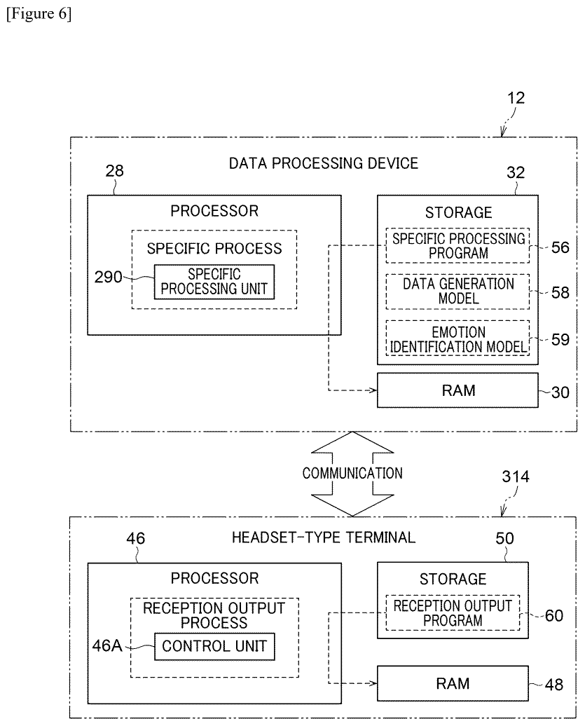

FIG. 6 shows an example of the main functions of the data processing device 12 and the headset-type terminal 314. As shown in FIG. 6, specific processing is performed by the processor 28 in the data processing device 12. The specific processing program 56 is stored in the storage 32.

The specific processing program 56 is an example of a “program” related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by the specific processing unit 290.

In the headset-type terminal 314, reception output processing is performed by the processor 46. The reception output program 60 is stored in the storage 50. Processor 46 reads the reception output program 60 from storage 50 and executes the read reception output program 60 on RAM 48. Reception output processing is achieved by processor 46 operating as control unit 46A according to the reception output program 60 executed on RAM 48.

Next, the specific processing performed by the specific processing unit 290 of the data processing device 12 is described. The various parts of the system described below are implemented by the data processing device 12 and the headset-type terminal 314. In the following description, the data processing device 12 is referred to as the “server,” and the headset-type terminal 314 is referred to as the “terminal.”

### EXAMPLE 1

The flow of the specific processing is the same as that described in Example 1 of the first embodiment, so the description is omitted.

### Application Example 1

The flow of the specific processing in Example 1 described in the above first embodiment is the same, so the explanation is omitted.

The specific processing unit 290 transmits the result of the specific processing to the headset-type terminal 314. At the headset-type terminal 314, the control unit 46A causes the speaker 240 and the display 343 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is what is known as generative AI (Artificial Intelligence). An example of a data generation model 58 is ChatGPT (registered trademark) (Internet search <URL:https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14. However, it may be performed by both the specific processing unit 290 of the data processing device 12 and the control unit 46A of the smart device 14. Furthermore, the specific processing unit 290 of the data processing device 12 may acquire or collect information necessary for processing from the smart device 14 or external devices, while the smart device 14 may acquire or collect information necessary for processing from the data processing device 12 or external devices.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the headset-type terminal 314.

### Fourth Embodiment

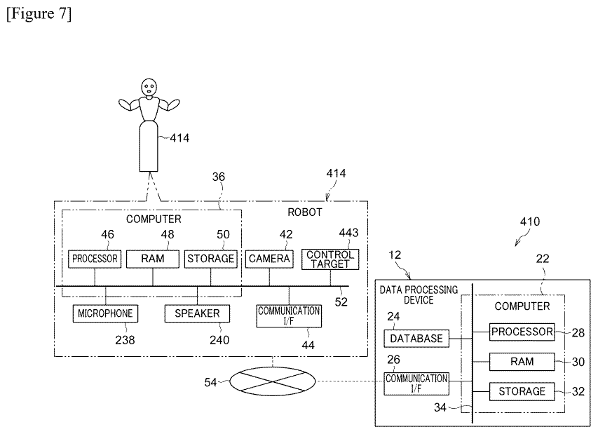

FIG. 7 shows an example configuration of the data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 is an example of a “computer” related to the technology of this disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is WAN (Wide Area Network) and/or LAN (Local Area Network) are examples.

Robot 414 includes a computer 36, a microphone 238, a speaker 240, a camera 42, a communication I/F 44, and a control target 443. Computer 36 includes a processor 46, RAM 48, and storage 50. Processor 46, RAM 48, and storage 50 are connected to bus 52. Furthermore, microphone 238, speaker 240, camera 42, and controlled object 443 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

The control target 443 includes a display device, LEDs for the eye section, and motors for driving the arms, hands, legs, etc. The posture and gestures of robot 414 are controlled by controlling the motors for the arms, hands, legs, etc. Part of the robot 414's emotions can be expressed by controlling these motors. Furthermore, the robot 414's facial expressions can also be expressed by controlling the light emission state of the LEDs in its eyes.

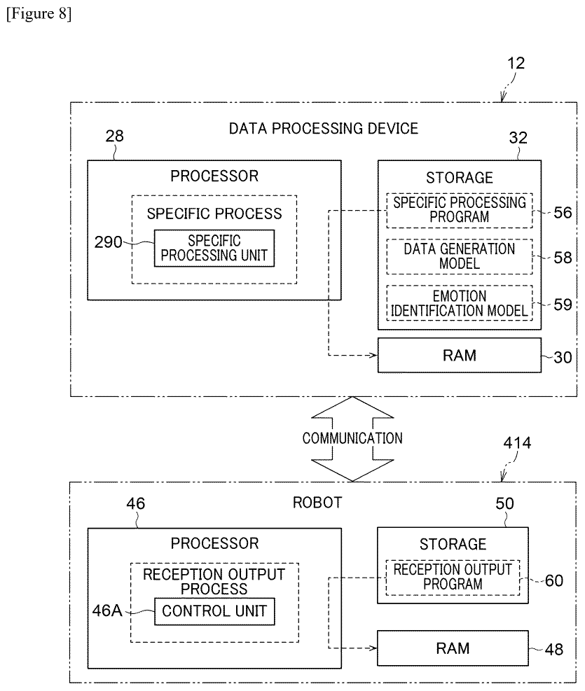

FIG. 8 shows an example of the main functions of the data processing device 12 and the robot 414. As shown in FIG. 8, specific processing is performed by the processor 28 in the data processing device 12. The specific processing program 56 is stored in the storage 32.

The specific processing program 56 is an example of a “program” pertaining to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by specific processing unit 290.

In robot 414, reception output processing is performed by processor 46. Storage 50 stores a reception output program 60. Processor 46 reads the reception output program 60 from storage 50 and executes the read reception output program 60 on RAM 48. Reception output processing is realized by the processor 46 operating as a control unit 46A according to the reception output program 60 executed on RAM 48.

Next, the specific processing performed by the specific processing unit 290 of the data processing device 12 is described. The various parts of the system described below are implemented by the data processing device 12 and the robot 414. In the following description, the data processing device 12 is referred to as the “server,” and the robot 414 is referred to as the “terminal.”

### EXAMPLE 1

The flow of the specific processing is the same as that described in Example 1 of the first embodiment, so the description is omitted.

### Application Example 1

The flow of the specific processing in Example 1 described in the first embodiment is the same as above, so the explanation is omitted.

The specific processing unit 290 transmits the result of the specific processing to the robot 414. In the robot 414, the control unit 46A causes the speaker 240 and the control target 443 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is what is known as generative AI (Artificial Intelligence). An example of a data generation model 58 is ChatGPT (registered trademark) (Internet search <URL:https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit may acquire step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using the generation AI. For example, the provision unit is implemented by the output device 40 of the smart device 14 or the specific processing unit 290 of the data processing device 12, and provides the generated cooking menu to the user. The correspondence between each unit and the device or control unit is not limited to the above examples and can be modified in various ways.

The above embodiment described a form where specific processing is performed by the data processing device 12, but the technology disclosed herein is not limited thereto; specific processing may also be performed by the robot 414.

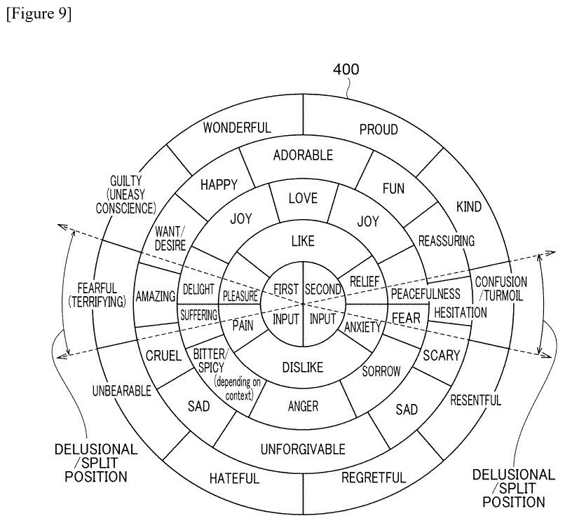

The emotion identification model 59, functioning as an emotion engine, may determine the user's emotion according to a specific mapping. Specifically, the emotion identification model 59 may determine the user's emotion according to an emotion map (see FIG. 9), which is a specific mapping. Furthermore, the emotion identification model 59 may similarly determine the robot's emotion, and the specific processing unit 290 may perform specific processing using the robot's emotion.

FIG. 9 is a diagram showing an emotion map 400 where multiple emotions are mapped. In the emotion map 400, emotions are arranged in concentric circles radiating from the center. Emotions closer to the center of the concentric circles represent more primitive states. Emotions representing states or behaviors arising from mental states are placed further out in the concentric circles. Emotion is a concept encompassing affect and mental states. Generally, emotions generated from reactions occurring within the brain are placed on the left side of the concentric circles. Generally, emotions induced by situational judgment are placed on the right side of the concentric circles. Generally, emotions generated from reactions occurring within the brain and also induced by situational judgment are placed in the upper and lower directions of the concentric circles. Furthermore, the upper part of the concentric circle contains “pleasant” emotions, while the lower part contains “unpleasant” emotions. Thus, the Emotion Map 400 maps multiple emotions based on the structure of their origin, with emotions that tend to occur simultaneously mapped close together.

These emotions are distributed around the 3 o'clock position on Emotion Map 400, typically oscillating between feelings of security and anxiety. In the right half of Emotion Map 400, situational awareness takes precedence over internal sensations, resulting in a calmer impression.

The inner part of the emotion map 400 represents the mind, while the outer part represents behavior. Therefore, the further out on the emotion map 400, the more visible the emotion becomes (manifesting in behavior).

Here, human emotions are based on various balances, such as posture and blood sugar levels. When these balances deviate from the ideal, it indicates a state of discomfort; when they approach the ideal, it indicates a state of comfort. Similarly, for robots, automobiles, motorcycles, etc., emotions can be created based on various balances, such as posture and battery level. When these balances deviate from the ideal, it indicates a state of discomfort; when they approach the ideal, it indicates a state of comfort. Emotion maps, for example, Dr. Mitsuyoshi's Emotion Map (Based on research on speech emotion recognition and brain physiological signal analysis systems for emotions, Tokushima University, Doctoral Dissertation: https://ci.nii.ac.jp/naid/500000375379). The left half of the emotion map displays emotions belonging to the “Reaction” domain, where sensory aspects predominate. The right half of the emotion map displays emotions belonging to the “Situation” domain, where situational awareness is dominant.

The emotion map defines two emotions that promote learning. One is the negative emotion around the center of the “repentance” or “reflection” area on the situation side. That is, when the robot experiences negative emotions like “I never want to feel this way again” or “I don't want to be scolded anymore.” The other is the positive emotion around “desire” on the reaction side. That is, when the robot feels positive emotions like “I want more” or “I want to know more.”

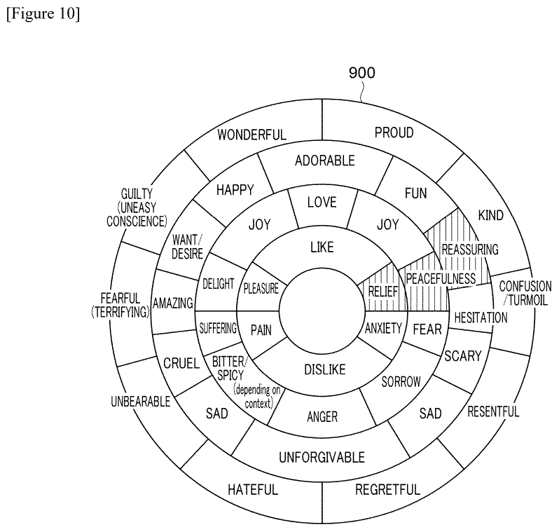

The emotion identification model 59 inputs the user input into a pre-trained neural network, obtains emotion values representing each emotion shown in the emotion map 400, and determines the user's emotion. This neural network is pre-trained based on multiple training data sets, which are combinations of user input and emotion values representing each emotion shown in the emotion map 400. Furthermore, this neural network is trained such that emotions positioned close to each other, as shown in the emotion map 900 in FIG. 10, have similar values. FIG. 10 illustrates an example where multiple emotions, such as “reassurance,” “tranquility,” and “encouragement,” have similar emotion values.

The above description primarily explains the system of the present disclosure in terms of the functions of the data processing device 12. However, the system of the present disclosure is not necessarily implemented on a server. The system of the present disclosure may be implemented as a general information processing system. For example, the present disclosure may be implemented as a software program operating on a personal computer or as an application operating on a smartphone, etc. The method of the present disclosure may be provided to users in a SaaS (Software as a Service) format.

The above embodiment illustrated an example configuration where specific processing is performed by a single computer 22. However, the technology of this disclosure is not limited thereto. Distributed processing may be performed by multiple computers, including computer 22, for specific processing. For example, data generation model 58 may be provided on an external device of data processing device 12, and said external device may generate data corresponding to input data. For example, the data generation model 58 may be provided in an external device of the data processing device 12, and data generation corresponding to input data may be performed in said external device.

The above embodiment described a configuration where the specific processing program 56 is stored in the storage 32. However, the technology disclosed herein is not limited to this. For example, the specific processing program 56 may be stored on a portable, computer-readable non-volatile storage medium, such as a USB (Universal Serial Bus) memory. The specific processing program 56 stored on the non-volatile storage medium is installed on the computer 22 of the data processing device 12. The processor 28 executes specific processing according to the specific processing program 56.

Alternatively, the specific processing program 56 may be stored on a storage device, such as a server, connected to the data processing device 12 via the network 54. Upon request from the data processing device 12, the specific processing program 56 is downloaded and installed on the computer 22.

It should be noted that it is not necessary to store the entire specific processing program 56 in a storage device such as a server connected to the data processing device 12 via the network 54, or to store the entire specific processing program 56 in the storage 32. It is also possible to store only a portion of the specific processing program 56.

Various types of processors can be used as hardware resources to execute the specific processing. Examples of processors include a CPU, which is a general-purpose processor that functions as a hardware resource for executing specific processing by executing software, i.e., programs. Additionally, processors may include dedicated electronic circuits, such as FPGAs (Field-Programmable Gate Array), PLDs (Programmable Logic Device), or ASICs (Application Specific Integrated Circuit), which are processors with circuit configurations specifically designed to execute particular processing tasks. Each processor incorporates or connects to memory, and each processor executes specific processing by utilizing this memory.

The hardware resources for executing specific processing may be comprised of one of these various processors, or a combination of two or more processors of the same or different types (e.g., a combination of multiple FPGAs, or a combination of a CPU and an FPGA). Furthermore, the hardware resources for executing specific processing may be comprised of a single processor.

Examples of configurations using a single processor include: First, a configuration where one processor is formed by combining one or more CPUs with software, with this processor functioning as the hardware resource executing specific processing. Second, there is a form using a processor that implements the entire system functionality, including multiple hardware resources executing specific processing, on a single IC chip, as exemplified by a System-on-a-chip (SoC). Thus, specific processing is implemented using one or more of the above various processors as hardware resources.

Furthermore, regarding the hardware structure of these various processors, more specifically, electrical circuits combining circuit elements such as semiconductor devices can be used. Also, the specific processing described above is merely one example. Therefore, it goes without saying that within the scope not deviating from the main purpose, unnecessary steps may be omitted, new steps may be added, or the processing order may be changed.

The above description and illustrations provide a detailed explanation of the aspects pertaining to the technology of this disclosure and represent merely one example of the technology disclosed herein. For example, the above descriptions of the configuration, functions, actions, and effects are merely examples of the configuration, functions, actions, and effects pertaining to the technology disclosed herein. Therefore, it goes without saying that within the scope that does not deviate from the spirit of the technology disclosed herein, unnecessary portions may be omitted, new elements may be added, or replacements may be made to the above-described content and illustrated content. Furthermore, to avoid complexity and facilitate understanding of the technical aspects of the present disclosure, descriptions of common technical knowledge and the like that are not particularly necessary for enabling the present disclosure to have been omitted from the above descriptions and illustrations.

All references, patent applications, and technical specifications cited herein are incorporated by reference to the same extent as if each reference, patent application, and technical specification were specifically and individually cited herein.

Regarding the above embodiments, the following is further disclosed.

### Supplementary Note 1

A system for realizing the metaverse transformation of a virtual store, comprising an acquisition unit, an analysis unit, a prompt generation unit, an image generation unit, a conversion unit, and a provision unit. The acquisition unit acquires HTML data using a web crawler based on the URL of the virtual store's website or online catalog input by the user. The analysis unit analyzes the acquired HTML data, extracts product categories, detailed information, images, and pricing information, and identifies product placement and layout information. The prompt generation unit generates prompts suitable for image generation AI based on the analysis results, including instructions for product placement, color, size, price display, etc. The image generation unit generates product visuals using the generated prompts, visually reproducing product placement and design. The conversion unit converts the generated images into a 2D metaverse platform, enabling products to be placed within a 2D space and allowing users to interact with them. The provision unit provides users with the metaverse-enabled virtual store, allowing them to select products and view detailed information.

A system as described in Supplementary Note 1, wherein the acquisition unit acquires HTML data of the virtual store using a web crawler based on a URL input by the user, and the analysis unit extracts product categories, detailed information, images, and price information from the acquired HTML data and identifies product placement and layout information. The analysis unit may also analyze the link structure within the page to identify navigation paths within the site, enabling it to understand how users move within the site.

The prompt generation unit generates prompts for each element of the site identified by the analysis unit, containing specific instructions for the image generation AI to accurately reproduce them. The image generation unit generates product visuals based on the generated prompts. The conversion unit converts the generated images into a 2D metaverse platform, and the provision unit provides the metaverse-enabled virtual store to the user, allowing the user to select products and view detailed information, as described in Claim 1. The prompt generation unit may also include instructions to maintain visual consistency, considering the product's theme and brand colors.

### SYMBOL EXPLANATION

10, 210, 310, 410 Data Processing System
12 Data Processing Device
14 Smart Device
214 Smart Glasses
314 Headset-type Terminal
414 Robot

What is claimed is:

1. A data processing system for converting a website into a two-dimensional metaverse space, comprising:
a server including:
at least one processor,
a storage storing a specific processing program and a data generation model, and
a communication interface connected to a network; and
a terminal connected to the server via the network and including a user interface,
wherein the at least one processor executes the specific processing program to perform:
acquiring, based on a URL received from the terminal, HTML data of a website by issuing an HTTP request and retrieving an HTML document;
constructing, from the HTML data, a document object model (DOM) tree representing a structure of the website;
parsing nodes of the DOM tree to extract layout information, text, image references, link information, and style information including information obtained from CSS files, and further identifying dynamic elements generated by JavaScript;
generating, for respective website elements identified through parsing, structured prompts including reproduction instructions relating to color, font, layout, placement, and visual consistency;
inputting the structured prompts to the data generation model to generate image data representing the respective website elements;
converting the generated image data into a two-dimensional metaverse space by arranging the generated image data in a tiled pattern and associating interactive operations with individual tiles; and
transmitting the two-dimensional metaverse space to the terminal and updating the metaverse space in real time based on user operations received from the terminal.

2. The system of claim 1, wherein acquiring the HTML data includes checking a robots.txt file to determine whether crawling is permitted.

3. The system of claim 1, wherein identifying dynamic elements includes parsing event listeners to identify user interaction patterns.

4. The system of claim 1, wherein the structured prompts are generated in a JSON format.

5. The system of claim 1, wherein the generated image data is stored in SVG or PNG format prior to conversion.

6. The system of claim 1, wherein the interactive operations include at least one of navigating to a link, displaying detailed information, zooming, or highlighting text.

7. A computer-implemented method executed by at least one processor of a server connected to a terminal, comprising:
receiving a URL of a website from the terminal;
acquiring HTML data corresponding to the URL using a web crawler;
constructing a DOM tree from the HTML data;
parsing the DOM tree to extract structural and content information including layout, text, images, links, and style information;
generating structured prompts for respective website elements based on the extracted information, the structured prompts including visual reproduction instructions;
inputting the structured prompts to a data generation model to generate image data corresponding to the respective website elements;
arranging the generated image data within a two-dimensional space to form a metaverse interface including interactive tiles; and
providing the metaverse interface to the terminal and reflecting user interactions in real time.

8. The method of claim 7, further comprising executing JavaScript to render dynamically generated content prior to constructing the DOM tree.

9. The method of claim 7, wherein parsing includes analyzing link structures within a page to identify navigation paths.

10. The method of claim 7, wherein generating the structured prompts includes instructions for maintaining brand color consistency.

11. The method of claim 7, wherein arranging the generated image data includes defining an interaction rule for each tile.

12. The method of claim 7, wherein providing the metaverse interface includes transmitting updated display information in response to user input from the terminal.

13. A non-transitory computer-readable storage medium storing instructions that, when executed by at least one processor, cause the processor to:
acquire HTML data of a website using a web crawler based on a URL;
construct a DOM tree representing a structure of the website;
extract layout and content information from the DOM tree;
generate structured prompts including reproduction instructions for respective website elements;
input the structured prompts to a data generation model to generate image data representing the website elements;
convert the generated image data into a two-dimensional metaverse space by arranging the image data and associating interactive operations with the arranged image data; and
transmit the two-dimensional metaverse space to a terminal for interactive display.

14. The storage medium of claim 13, wherein extracting layout and content information includes parsing CSS files.

15. The storage medium of claim 13, wherein the structured prompts include instructions relating to product placement or element placement.

16. The storage medium of claim 13, wherein converting includes arranging the image data in a tiled pattern.

17. The storage medium of claim 13, wherein the instructions further cause real-time synchronization between the server and the terminal.

18. The storage medium of claim 13, wherein the data generation model receives the structured prompts and outputs image data in response to the prompts.
